(19) United States
(12) Patent Application Publication
(10) Pub. No.: US 2009/0301998 A1
(43) Pub. Date: Dec. 10, 2009

(54) METHOD OF FORMING NOZZLE HOLE AND METHOD OF MANUFACTURING INKJET RECORDING HEAD

(75) Inventors: Hiroki UCHIYAMA, Ashigarakami-gun (JP); Shuji TAKAHASHI, Ashigarakami-gun (JP); Shinya SUGIMOTO, Minato-ku (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/478,134

(22) Filed: Jun. 4, 2009

(30) Foreign Application Priority Data
Jun. 9, 2008 (JP) 2008-151002

(51) Int. Cl. B44C 1/22

(52) U.S. Cl. 216/27

(57) ABSTRACT

A first substrate 10 having a channel 12 which passes through the inside thereof and an opening 14a or 14b of the channel which is formed on at least one side thereof, and a second substrate 20 for forming a nozzle hole communicating with the channel are prepared. The second substrate is bonded to the one side of the first substrate where the channel opening 14b is formed so that the opening is blocked by the second substrate. The second substrate is etched with a mixed etching fluid, which contains a high-pressure fluid and an etching solution, fed thereto via the channel of the first substrate, thereby forming the nozzle hole 22 communicating with the channel.

### CROSS REFERENCE TO RELATED APPLICATION

This application claims priority under 35 USC 119 from Japanese Patent Application No. 2008-151002, the disclosure of which is incorporated herein by reference.

### BACKGROUND OF THE INVENTION

1. Field of the Invention

The present invention relates to a method of forming a nozzle hole and a method of manufacturing an inkjet recording head, and more particularly, to a method of manufacturing an inkjet recording head having nozzle holes formed with high accuracy by wet etching.

2. Description of the Related Art

As methods currently used for manufacturing inkjet recording heads, there is a method of bonding a substrate in which a pressure chamber and a channel has been formed and a substrate in which a nozzle has been formed, together in position, and a method of machining one substrate from both sides to form a pressure chamber, a channel, a nozzle hole and others individually.

For instance, the method in which one single-crystal silicon substrate is used, and a damper part temporarily storing ink is formed by etching from one surface side of the silicon substrate, and then a conical nozzle part extending from the damper part is formed by wet etching, and thereafter an outlet communicating with the nozzle part is formed by wet etching from the other surface side of the silicon substrate is disclosed (see JP-A No. 2001-287369).

According to the method disclosed in JP-A No. 2001-287369, though the number of substrates used in manufacturing an inkjet recording head can be reduced, separate formation of the nozzle part and its outlet from both sides of the substrate requires highly-accurate alignment, and tends to result in misalignment. Misalignment of the nozzle part gives rise to degradation in image quality because it causes off-course jetting of ink droplets at the time of jetting ink to result in an adhering-position shift, variations in volumes of ink droplets, and so on.

Further, in forming a nozzle part subsequently to the formation of a damper part, the nozzle part cannot be formed with a high degree of accuracy when the damper part is fine, because an etching solution is difficult to enter the damper part and poor venting of gas generated during the etching results in uneven etching. Furthermore, in forming a thermally-oxidized film as a protective film after the formation of a damper part, there is a fear that warpage of the substrate occurs upon heating to affect adversely the formation of the nozzle part.

On the other hand, there is a proposal of the method in which a nozzle part is formed by bonding two substrates differing in crystal orientation from each other, providing a protective mask having an etching window on one surface of the bonded substrates, forming an etching hole (channel) by wet etching of only one substrate through the etching window, and further etching the other substrate by use of the etching hole as an etching window (see JP-A No. 7-201806).

According to the method disclosed in JP-A No. 7-201806, misalignment between the etching hole and the nozzle part can be avoided, but in forming a fine channel in particular, there is a fear of raising uniformity and reproducibility problems that, because of the viscosity and surface tension of an etching solution specific to wet etching, non-uniform transport of the etching solution and inclusion of air bubbles into the etching solution tend to occur and lead to uneven etching.

Further, in forming a nozzle via an etching hole (channel), the interior of the etching hole is also etched, and thereby variations in the channel shape may occur. Furthermore, when a tapering part (nozzle part) is formed after forming a straight part (channel part), there arise differences in dimensions including the outer diameter of the tapering part unless the crystal orientations of two substrates used are made the same in advance, so the result is that alignment in the crystal orientation is required of substrates to be bonded together.

### SUMMARY OF THE INVENTION

In view of these circumstances, the invention has been made and provides the following methods for forming a nozzle hole and manufacturing an inkjet recording head.

According to a first aspect of the invention, a method of forming a nozzle hole includes:

preparing a first substrate having a channel which passes through the inside thereof and an opening of the channel which is formed on at least one side thereof, and a second substrate for forming a nozzle hole communicating with the channel,

bonding the second substrate to the one side of the first substrate where the opening of the channel is formed so that the opening is blocked by the second substrate, and

etching the second substrate by feeding a mixed etching fluid, which contains a high-pressure fluid and an etching solution, to the second substrate via the channel of the first substrate, thereby forming the nozzle hole communicating with the channel, is provided.

According to a second aspect of the invention, a method of manufacturing an inkjet recording head, including forming a nozzle hole by the method according to the first aspect of the invention, is provided.

### BRIEF DESCRIPTION OF THE DRAWINGS

FIG. 1 is a process flow diagram schematically illustrating processes included in a first embodiment of the invention, namely a process (A) of preparing a first substrate, a process (B) of forming a first protective film and a process (C) of bonding both substrates together.

FIG. 2 is a process flow diagram schematically illustrating processes included in the first embodiment of the invention, namely a process (D) of forming a second protective film, a process (E) of forming a nozzle hole and a process (F) of removing the second protective film.

FIG. 3A is a schematic diagram showing one example of a combination of the shape of an opening of a channel and the shape of a nozzle hole formed in a second substrate.

FIG. 3B is a schematic diagram showing another example of a combination of the shape of a channel opening and the shape of a nozzle hole formed in a second substrate.

FIG. 3C is a schematic diagram showing another example of a combination of the shape of a channel opening and the shape of a nozzle hole formed in a second substrate.

FIG. 4 is a phase diagram showing a supercritical fluid region and a subcritical region.

FIG. 5A is a schematic cross-sectional view of a nozzle in the shape of a truncated pyramid which is formed in the second substrate.

FIG. 5B is a schematic plan view of a nozzle in the shape of a truncated pyramid which is formed in the second substrate.

FIG. 6 is a flowchart showing an example of an etching process.

FIG. 7 is a schematic block diagram illustrating an example of the structure of supercritical fluid apparatus usable in the invention.

FIG. 8 is a schematic drawing illustrating states of a high-pressure fluid and an etching solution in the etching process.

FIG. 9 is a process flow diagram schematically illustrating processes included in a second embodiment of the invention.

FIG. 10A is a schematic diagram showing a case where the openings of a bent channel are formed on both surfaces of a first substrate, respectively.

FIG. 10B is a schematic diagram showing a case where the openings of a bent channel are formed on one surface and one flank of the first substrate, respectively.

### DETAILED DESCRIPTION OF THE INVENTION

The invention is specifically described below while referring to drawings attached herewith. Additionally, the shape and size of each constituent part and the configuration of constituent parts in the drawings are merely shown in rough outlines at levels allowing comprehension of the invention, so the invention should not be construed as being limited particularly to those which are shown in the drawings.

The nozzle-hole formation method relating to the invention includes:

preparing a first substrate having a channel which passes through the inside thereof and an opening of the channel which is formed on at least one side thereof, and a second substrate for forming a nozzle hole communicating with the channel,

bonding the second substrate to the one side of the first substrate where the opening of the channel is formed so that the opening is blocked by the second substrate, and

etching the second substrate by feeding a mixed etching fluid, which contains a high-pressure fluid and an etching solution, to the second substrate via the channel of the first substrate, thereby forming the nozzle hole communicating with the channel.

### (1) First Embodiment of the Invention

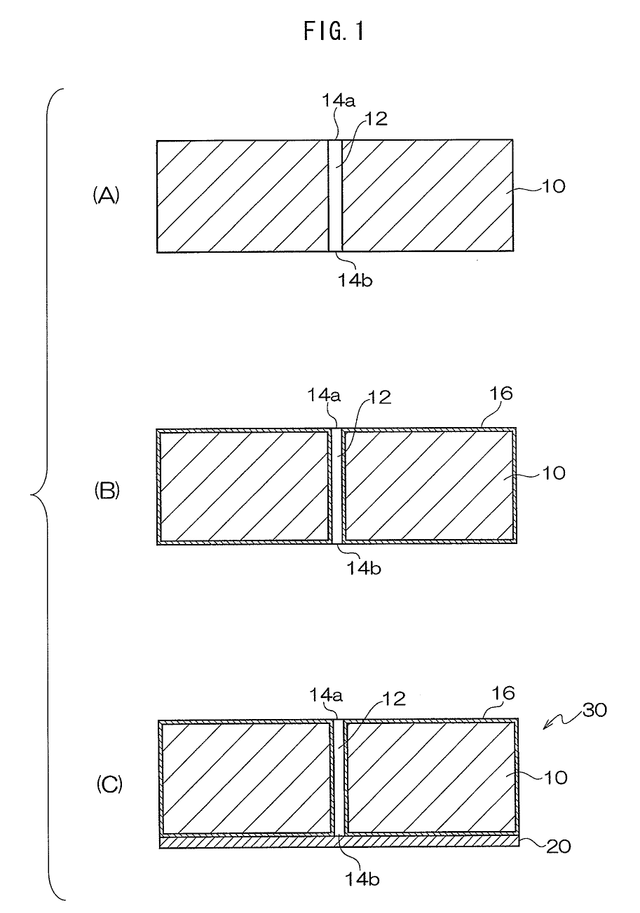

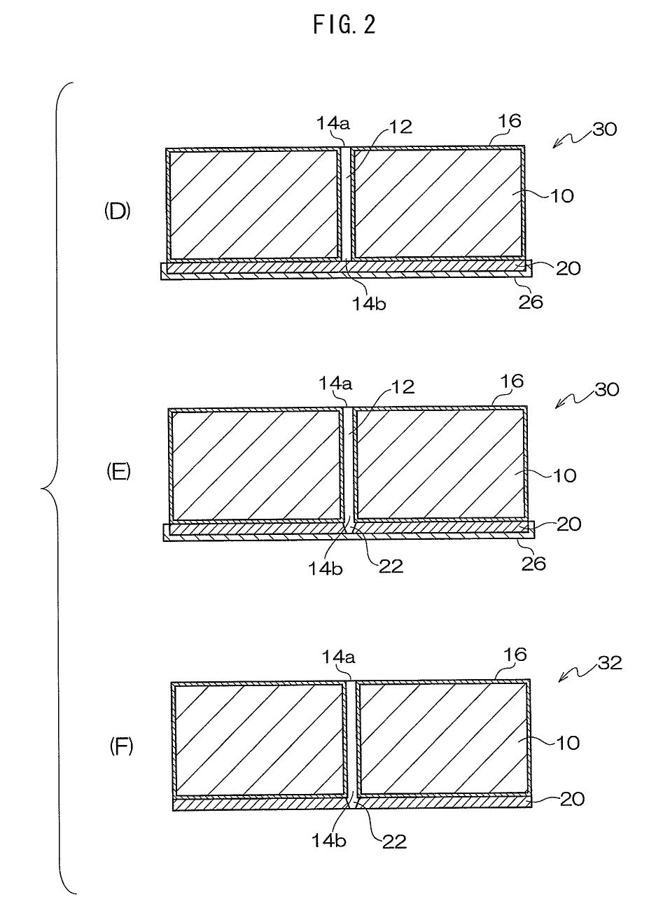

FIGS. 1 and 2 schematically illustrate one example of a process for manufacturing an inkjet recording head by utilizing a method of forming a nozzle-hole relating to the invention.

### [Preparation of Substrates]

In the first place, a first substrate 10 which has a channel 12 passing the inside thereof and an opening 14a or 14b of the channel 12, which is formed on at least one surface of the substrate, and a second substrate 20 for forming a nozzle hole 22 communicating with the channel 12 are prepared.

<First Substrate>

As the first substrate (channel substrate) 10, for example, a silicon substrate through which the channel 12 passes in the direction of thickness as shown in FIG. 1(A) can be used.

In forming such a channel 12 in a silicon substrate, mask patterning is performed in one surface of the silicon substrate by photolithography so that silicon is exposed only in the area corresponding to the opening 14a of the ink channel 12 to be formed. Incidentally, though the case of forming only the channel 12 is described herein, a pressure chamber, an ink supply route or the like may also be formed.

For instance, a resist is coated on the silicon substrate. The resist may be either a negative resist or a positive resist, and examples of a resist usable herein include OFPR and TSMR manufactured by TOKYO OHKA KOGYO CO., LTD., and AZ 1500 Series and 10XT manufactured by AZ Electronic Materials. And no particular restriction is imposed on the method of coating such a resin. For instance, the resist is coated on one surface of the substrate by use of a spin coating method, a dipping method or a spray coating method. The thickness of a resist film coated may be determined according to etching conditions and the thickness of a silicon substrate to be etched, and it is chosen e.g. from a range of 10 to 20 μm.

After the resist film is provided on the substrate, soft baking thereof is carried out by means of a heating device such as a hot plate or an oven. Depending on the kind and thickness of the resist film, the baking is generally carried out at a temperature on the order of 70° C. to 200° C. for a time on the order of 60 to 3,600 seconds. For instance, in the case of using such a positive resist as AZ 10XT from AZ Electronic Materials and a hot plate, the soft baking is carried out at 100° C. for a time on the order of 90 seconds.

Next, light exposure is carried out in order to form the resist film into an intended mask pattern. Herein, according to the kind of the resist used (whether the resist is a negative or positive one), the light exposure may be carried out so that, by development subsequent to the light exposure, the resist film is removed in the area where the channel 12 is to be formed, while it remains in the other area.

As exposure apparatus, a contact aligner or a stepper may be used. For example, a contact aligner MA6 manufactured by SUSS MicroTec can be used. The exposure value may be determined according to the kind and film thickness of the resist. For instance, when AZ 10XT is formed into a resist film having a thickness of 10 μm, it is advisable to choose the exposure value of 800 mJ/cm².

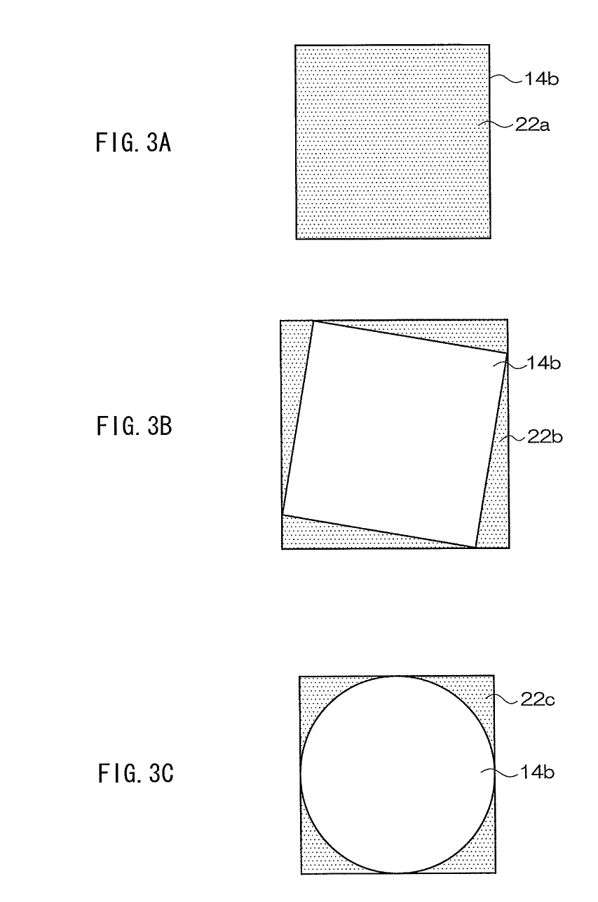

The mask pattern may be chosen according to the shape of the channel 12 to be formed in the interior of the substrate. For instance, when the channel 12 is quadrangular in outside shape (cross section in a direction perpendicular to the flow of ink), there may be a case where the peripheral diameter of a nozzle formed in the second substrate 20 varies because of face-orientation deviation. More specifically, so long as the opening 14b in the first substrate 10 which acts as a mask agrees with crystal orientation of the second substrate 20 at the later time of forming the nozzle hole 22 in the second substrate 20 by means of crystal anisotropy etching, the opening of the nozzle 22a is formed, as shown in FIG. 3A, in a size equivalent to the opening 14b of the channel 12. On the other hand, when the face orientation of the opening 14b of the channel 12 deviates from the crystal orientation of the second substrate 20, the opening of the nozzle 22b formed by the etching becomes, as shown in FIG. 3B, greater in diameter than the opening 14b of the channel 12.

Alternatively, in a case where the opening 14b of the channel 12 is circular in shape, the peripheral diameter of the opening 14b becomes equal to the opening diameter of the nozzle 22c as shown in FIG. 3C. More specifically, forming the channel 12 in the first substrate 10, which acts as a substitute for a mask used at the time of nozzle formation, into the shape of a cylinder eliminates the need for alignment with crystal orientation (face-orientation alignment of the first substrate 10 with the second substrate 20).

For these reasons, it is better for formation of a nozzle hole with higher accuracy to make a mask pattern for forming the channel 12 into such a shape as to expose a part of the surface of the first substrate 10 in the shape of a circle (a perfect circle, a circle close to a perfect circle, an ellipse or the like), and through the medium of this mask, to form the cylindrical channel 12 (having circular openings 14a and 14b).

Development is carried out after the light exposure. A developer used herein may be chosen depending on the kind of the resist, and examples thereof include NMD-3 manufactured by TOKYO OHKA KOGYO CO., LTD., AZ400K DEVELOPER manufactured by AZ Electronic Materials, and so on. For instance, when the AZ10XT is used as the resist, a developer is prepared by diluting 1 part AZ400K with 4 parts purified water, and the substrate having undergone the light exposure is immersed into this developer at 23° C. for 300 seconds, and then rinsed twice with purified water in 300 seconds.

After the development, elimination of water droplets is performed by means of a spin dryer or the like for the purpose of eliminating the water adhering to the substrate.

Then, the resist film patterned by the exposure and development is subjected to post baking. The post baking may also be carried out by means of a hot plate, an oven or the like. The temperature for the post baking is generally on the order of 90° C. to 200° C., and the time for the post baking is on the order of 60 to 3,600 seconds. In the case of using a positive resist, such as AZ10XT manufactured by AZ Electronic Materials, the post baking is performed by using a hot plate at 120° C. for 180 seconds.

Alternatively, a hard mask may be used in place of the resist mask as recited above. By using a metal such as Al, an oxide such as SiO₂ or a nitride such as SiN for the hard mask, the mask selectivity at the time of etching is raised, so the mask film thickness may be small. Formation of such a hard mask having a small thickness allows patterning in high resolution, and thereby highly-accurate channel formation becomes possible. Incidentally, as a method of forming a hard mask made of metal, oxide, nitride or so on, the method of forming a film on one overall surface of a silicon substrate by sputtering, CVD or the like and then patterning the film by photolithography may be adopted.

After forming a mask, through the medium of this mask, the silicon substrate is processed by dry etching to form the channel 12.

The dry etching of the silicon substrate can be performed suitably by the so-called Bosch process (the method of etching by repeated cycles of etching and protection of the etched side wall). For example, PEGASUS or HRM/HRMX manufactured by STS plc, or MS3200 manufactured by Alcatel can be used therein. More specifically, repeated cycles of etching with SF₆ and deposition with C₄F₈ are performed.

By the foregoing dry etching, the silicon substrate is processed via the circular exposed area of the resist mask, and as shown in FIG. 1(A), the channel 12 passing the substrate 10 in the thickness direction and having the openings 14a and 14b at both surfaces of the substrate 10 is formed.

In the case of using the resist mask, the resist is removed after the formation of the channel 12 by ashing treatment using oxygen plasma or the like. In addition, the deposition film produced at the time of etching is removed. Oxygen plasma treatment and a solution prepared specifically for removal of deposition film may be employed. For example, ZEOROLA HTA manufactured by ZEON CORPORATION or NOVEC manufactured by Sumitomo 3M limited may be used as the solution for removal of the deposition film.

Further, by carrying out RCA cleaning as required, organic impurities adhering to the substrate surface, silicon dioxide film, metallic impurities and so on are removed.

Formation of First Protective Film

After the formation of the channel 12, the first protective film 16 against a mixed etching fluid used in an etching process described hereinafter is formed at least on the inside of the channel 12 of the first substrate 10 (FIG. 1(B)).

The first protective film 16 is a protective film for preventing the channel 12 itself from being etched at the time when the second substrate 20 is etched via the channel 12 in the first substrate 10 in the etching process performed hereafter. Although the first protective film 16 is therefore formed in at least the interior of the channel 12, it is preferred from the viewpoints of easiness of film formation and easiness of etching in the following process that the protective film 16 is formed on the entire surface of the substrate 10 including the inside surface of the channel 12.

As the first protective film 16, a silicon dioxide film, a silicon nitride film or a metallic film such as an alumina film may be formed by using a thermal oxidation method, a sputtering method, a vacuum evaporation method, a CVD method, an ALD method or so on. Of those films, a silicon dioxide film is especially preferred, and it may be formed by thermally oxidizing the first substrate 10. The silicon dioxide film formed by the thermal oxidation method is preferred because it is free of pin holes and the like, can be formed uniformly with ease on the entire surface of the substrate including the inside surface of the channel 12, and has superior resistance to ink.

The thickness of the first protective film 16, though depends on the diameter of the channel 12, is preferably controlled to a range of 0.1 μm to 5.0 μm from the viewpoints of ensuring protection of the first substrate 10 during the etching process, preventing the channel 12 from being filled with the protective film 16 and avoiding reduction in productivity.

Incidentally, when the first protective film 16 is formed on the entire surface of the substrate 10, the protective film 16 formed on the surface portion of the substrate 10 to which the second substrate 20 is to be bonded may be removed as required e.g. by CMP (Chemical Mechanical Polishing) or dry etching.

On the other hand, when the first substrate 10 is highly resistant to corrosion by a mixed etching fluid, it is not necessarily required to provide the first protective film 16 on the substrate 10.

<Second Substrate>

A second substrate (nozzle substrate) 20 for forming a nozzle hole 22 is prepared. As the second substrate 20 as well, a silicon substrate can be suitably used. It is especially suitable to use a silicon substrate whose face orientation is <100>. Although specifics thereof will be explained in description of the etching process, using the <100> substrate allows formation of the nozzle hole 22 into the shape of a square pyramid facing toward the thickness direction of the second substrate 20.

In addition, the thickness of the second substrate 20 may be chosen according to the length of the nozzle hole 22 to be formed. In the case of forming nozzles for an inkjet recording head, a silicon substrate having a thickness e.g. on the order of 10 to 100 μm can be suitably used.

[Bonding]

Next, the second substrate 20 is bonded to one surface of the first substrate 10, at which the opening 14b of the channel 12 is formed, so as to block the opening 14b (FIG. 1(C)).

After the second substrate 20 is cleaned by RCA cleaning or the like, the second substrate 20 is bonded to the surface of the first substrate 10 at which the opening 14b of the channel 12 already formed in the first substrate 10 is formed. As a method of bonding both the substrates 10 and 20 together, performance of Si—Si or SiO₂—Si direct bonding or room-temperature bonding may be adopted.

In the case of performing direct bonding, both the substrates 10 and 20 are subjected in advance to cleaning and surface treatment by using chemicals, such as an acid, and purified water, and thereby oxide film (the so-called native oxide film) is thinly formed on the surfaces of both the substrates 10 and 20. Further, treatment for adhering a number of hydroxyl groups to the surfaces of both the substrates 10 and 20 (hydrophilization treatment) is performed. Herein, since the oxide film is formed on the surfaces of the substrates 10 and 20, an oxide film (SiO₂) may be formed in advance on the substrates.

Then, both the substrates 10 and 20 having undergone the hydrophilization treatment are superimposed on each other, and bonded together. By superimposing two silicone substrates 10 and 20 on each other and bringing them into contact with each other, the substrates 10 and 20 are automatically bonded together by attraction force between them (interfacial attraction). This bonding is thought to be made by hydrogen bonding between hydroxyl groups on the silicon substrate surfaces having been rendered hydrophilic

Bonding the substrates 10 and 20 together is performed at room temperature. However, such a bonding state that the two substrates are bonded together by hydrogen bonding at room temperature is low in strength to bond them together and sensitive to moisture and the like, so the substrates bonded together are further subjected to thermal treatment. The thermal treatment is carried out at a temperature e.g. on the order of 1,000° C. By this thermal treatment, the water remaining between the substrates is removed, and direct bonding occurs between silicon atoms.

In another case of carrying out room-temperature bonding, room-temperature wafer bonding apparatus made e.g. by MITSUBISHI HEAVY INDUSTRIES, LTD. is used, and the substrates 10 and 20 can be bonded together by irradiating each of their surfaces to be bonded together with an argon-ion beam in vacuum, bringing the irradiated surfaces into contact with each other, and applying pressure thereto. In this case, the substrates 10 and 20 can be firmly bonded together without undergoing thermal treatment; as a result, the substrates bonded are free of warpage and deformation caused by heating, which can ensure manufacturing of an inkjet recording head with higher accuracy.

Formation of Second Protective Film

After the first substrate 10 and the second substrate 20 are bonded together to obtain the bonded substrate 30, a second protective film 26 against a mixed etching fluid to be used in the following etching process is formed on the surface of the second substrate 20, except for a portion where the first substrate 10 is bonded to the second substrate 20 and a portion which communicates with the channel 12 of the first substrate 10 (FIG. 2(D)).

The second protective film 26 is a protective film for preventing the surface of the second substrate 20 from being etched when the second substrate 20 is etched via the channel 12 in the first substrate 10 in the following etching process.

The thickness of the second protective film 26, though depends on the thickness of the second substrate 20, is preferably in a range of 1 μm to 20 μm from the viewpoints of ensuring protection of the second substrate 20 in the etching process.

As the second protective film 26, an organic film (e.g. Cytop manufactured by ASAHI GLASS CO., LTD. or ProTEK manufactured by Dow Chemical Company), a resist and the like may be used. Considering easiness of removal after the etching process, a resist is used to advantage. Examples of a resist include OFPR and TSMR manufactured by TOKYO OHKA KOGYO CO., LTD., AZ 1500 Series and 10XT manufactured by AZ Electronic Materials, and SU-8 Series manufactured by KAYAKU MICROCHEM CO., LTD. In a method usable for forming the second protective film 26, film formation is carried out using a spin coating method, a spray coating method, a dipping method or the like, and then the film formed is subjected to heat treatment at temperatures ranging from 100° C. to 300° C. by means of a hot plate, an oven or the like.

The material especially suitable for the second protective film 26 is a resist material that offers resistance to an etching solution used at the time of nozzle formation, does not cause foaming, swelling, peeling and dissolution when exposed to a high-pressure fluid such as a supercritical fluid, and can be removed with ease after the nozzle formation because it comes to dissolve in a high-pressure fluid when external stimulation such as light exposure is applied thereto. An example of a resist material having such properties is a photosensitive liquid resist such as polymethylphenylsilane. Polymethylphenylsilane is a resist material whose solubility in supercritical carbon dioxide can be changed from the insoluble state to the soluble state by light exposure. So long as a resist can be removed with supercritical carbon dioxide after the etching process, organic solvents or the like generally used at the time of resist removal becomes unnecessary, and reduction in waste liquid generated in the process can be achieved.

The etching is performed by feeding a mixed etching fluid containing a high-pressure fluid and an etching solution from the opening 14b to the second substrate 20 via the channel 12 of the first substrate 10, and thereby the nozzle hole 22 communicating with the channel 12 is formed.

By wet anisotropic etching with such a high-pressure fluid, the nozzle hole 22 can be formed in the second substrate 20. The constituents of the mixed etching fluid may be chosen appropriately according to the properties of a material forming the second substrate 20 targeted for etching. For instance, the high-pressure fluid used herein is a mixed etching fluid prepared by mixing a high-pressure fluid, such as supercritical carbon dioxide, with at least one kind of etching solution, and further adding thereto additives and a surfactant in some cases.

<High Pressure Fluid>

The “high pressure fluid” in the invention means typically a fluid containing a supercritical fluid or a subcritical fluid.

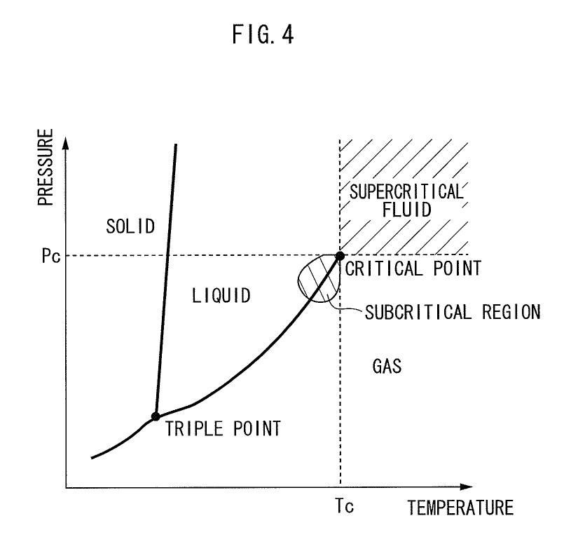

FIG. 4 is a state diagram of a pure substance. As shown in FIG. 4, the supercritical fluid is a high pressure fluid in a state where the conditions of the pressure and the temperature are P>Pc (critical pressure), and T>Tc (critical temperature) at the vicinity of a critical point. For example, in the case of carbon dioxide, the critical temperature is 304.5K, and the critical pressure is 7.387 MPa, and in a state where temperature and pressure are both greater than the critical temperature and the critical pressure, the carbon dioxide becomes a supercritical fluid (supercritical carbon dioxide).

On the other hand, the subcritical fluid refers to a fluid which is in a region in a vicinity before the critical point, and the subcritical fluid is in a state where the compressed liquid and the compressed gas coexist. A fluid in this region is distinguished from the supercritical fluid, but since the physical properties such as the density are continuously changed, there is no physical border, and the subcritical fluid in such a region may also be used as the high pressure fluid in the invention. In addition, a fluid in such a subcritical region and supercritical region near the critical point is also called a high density liquefied gas.

The high-pressure fluid usable in the invention has no particular restriction as to its kind, and may be chosen appropriately from supercritical fluids or subcritical fluids according to the kind and others of an etching solution used in combination therewith. Examples of such a high-pressure fluid include those of carbon dioxide, oxygen, argon, krypton, xenon, ammonia, trifluoromethane, ethane, propane, butane, benzene, methyl ether, chloroform, water and ethanol. Among them, the supercritical fluid of carbon dioxide in particular is used to advantage in terms of critical point suitable for practical use, environmental adaptability, non-toxic property and so on.

<Etching Solution>

With respect to the etching solution, there are an acidic etching solution and an alkaline etching solution.

The acidic etching solution used mainly is a three-component etching solution prepared by diluting a mixed acid containing hydrogen fluoride (HF) and nitric acid (HNO₃) with water (H₂O) or acetic acid (CH₃COOH), and has no anisotropy regarding the etching rate in contrast to an alkaline etching solution.

However, the etching rate depends largely on the concentration gradients of reactant species and reaction products at the substrate surface in the etching solution, and there is a fear that in-plane variations in etching rate occur due to unevenness of the diffusion layer thickness arising from a non-uniform flow and the like of the etching solution, and thereby the flatness of the substrate is impaired to result in the occurrence of undulations or asperities of the order of millimeters at the surface having undergone the etching.

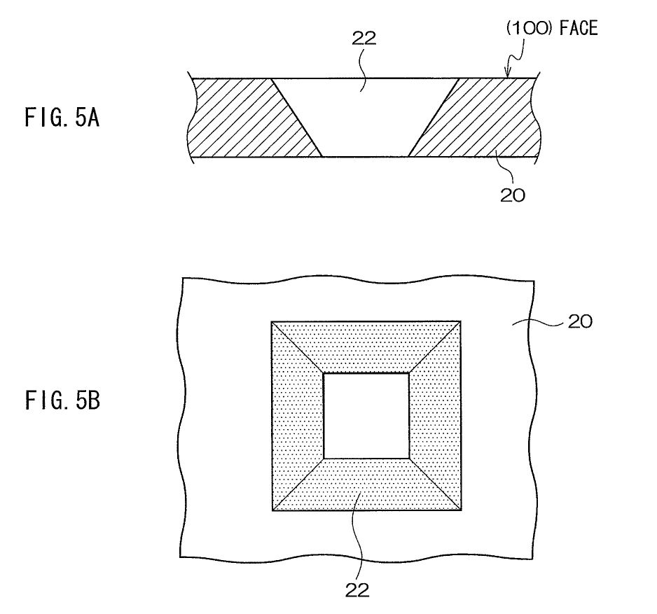

On the other hand, the etching rate of an alkaline etching solution does not depend on the concentration gradients and the like of reactant species and products in the etching solution, and the flatness of the substrate is maintained at its original high level even after the substrate undergoes the etching. Therefore, the alkali etching is more favorable than the acid etching for the purpose of ensuring high flatness. In addition, the alkaline etching solution performs anisotropic etching that the etching rate varies greatly depending on crystal orientations and, though the degree of anisotropy depends on the composition of the alkali solution used, the etching rate in the <100> orientation is considerably faster than that in the <111> orientation. So, when the silicon substrate having the orientation of (100) undergoes alkali etching, the (111) face slow in etching rate remains and, as shown in FIG. 5A and FIG. 5B, the silicon substrate is etched in the form of a truncated square pyramid in the thickness direction of the second substrate 20 and a tapered nozzle hole 22 is formed therein.

Accordingly, in the case of forming the tapered nozzle hole 22 for an inkjet recording head, it is appropriate to use an alkaline etching solution which allows anisotropic etching. Examples of an alkaline etching solution include alkaline solutions containing KOH, NaOH, hydrazine, ethylenediaminepyrocatechol (EDP) and tetramethylammonium hydroxide (TMAH), respectively, mixed solution thereof, and these alkaline solutions to which additives such as a surfactant are added.

<Additive>

Mixing of an additive in a high-pressure fluid aids in increasing the solubility of an etching composition. The additive used in an etching composition is preferably alcohol. Examples of alcohol usable therein include straight-chain or branched C1-C6 alcohol compounds (such as methanol, ethanol and isopropanol) and mixtures of two or more of these alcohol compounds. Of these alcohol compounds, methanol and isopropanol (IPA) are especially preferable.

<Surfactant>

When a high-pressure nonpolar fluid such as supercritical carbon dioxide is used, the etching solution is incompatible with such a fluid, so there occurs a separation between the supercritical carbon dioxide and the etching solution. Therefore, the etching solution is homogenized through emulsification by addition of a surfactant, and thereby improvement in reaction efficiency can be achieved. The surfactant to be added may be at least one or more kinds of surfactants chosen from those currently in use, including anionic, nonionic, cationic and amphoteric surfactants. The suitable amount of surfactant(s) used has no particular limits, but it is generally from about 0.0001 wt % to about 30 wt %, particularly 0.001 wt % to 10 wt %, with respect to the etching solution.

Incidentally, since the compatibility is ensured in a combination of a high-pressure fluid of a polar substance such as supercritical water and an etching solution containing a polar substance, the addition of a surfactant becomes unnecessary.

Examples of the anionic surfactant are not limited to, but include soap, alphaolefinsulfonate, alkylbenzenesulfonate, alkylsulfate, alkylether sulfate, phenylether sulfate, methyl taurine acid salt, sulfosuccinate, ethersulfonate, sulfonated oil, phosphate, perfluoroolefinsulfonate, perfluoroalkylbenzenesulfonate, perfluoroalkylsulfate, perfluoroalkylethersulfate, perfluorophenylethersulfate, perfluoromethyl taurine acid salt, sulfoperfluorosuccinate, and perfluoroethersulfonate.

Examples of a cation of a salt of the anionic surfactant are not limited to, but include sodium, potassium, calcium, tetraethylammonium, triethylmethylammonium, diethyldimethylammonium, and tetramethylammonium, and cations capable of being electrolyzed may be used.

Examples of the nonionic surfactant are not limited to, but include C1-25 alkylphenol system, C1-20 alkanol, polyalkylene glycol system, alkylolamide system, C1-22 fatty acid ester system, C-22 aliphatic amine, alkylamine ethylene oxide adduct, arylalkylphenol, C1-25 alkylnaphthol, C1-25 alkoxylated phosphoric acid (salt), sorbitan ester, styrenated phenol, alkylamine ethylene oxide/propylene oxide adduct, alkylamine oxide, C1-25 alkoxylated phosphoric acid (salt), perfluorononylphenol system, perfluoro higher alcohol system, perfluoropolyalkylene glycol system, perfluoroalkylolamide system, perfluorofatty acid ester system, perfluoroalkylamine ethylene oxide adduct, perfluoroalkylamine ethylene oxide/perfluoropropylene oxide adduct, and perfluoroalkylamine oxide.

Examples of the cationic surfactant are not limited to, but include lauryltrimethylammonium salt, stearyltrimethylammonium salt, lauryldimethylethylammonium salt, dimethylbenzyllaurylammonium salt, cetyldimethylbenzylammonium salt, octadecyldimethylammonium salt, trimethylbenzylammonium salt, hexadecylpyridinium salt, laurylpyridinium salt, dodecylpicolinium salt, stearylamineacetate, laurylamineacetate, octadecylamineacetate, monoalkylammonium chloride, dialkylammonium chloride, ethylene oxide adduct-type ammonium chloride, alkylbenzylammonium chloride, tetramethylammonium chloride, trimethylphenylammonium chloride, tetrabutylammonium chloride, acetic acid monoalkylammonium, imidazoliniumbetaine system, alanine system, alkylbetaine system, monoperfluoroalkylammonium chloride, diperfluoroalkylammonium chloride, perfluoroethylene oxide adduct-type ammonium chloride, perfluoroalkylbenzylammonium chloride, tetraperfluoromethylammonium chloride, triperfluoromethylphenylammonium chloride, tetraperfluorobutylammonium chloride, acetic acid monoperfluoroalkylammonium, and perfluoroalkylbetaine system.

Examples of the amphoteric surfactant include betaine, sulfobetaine, and aminocarboxylic acid, as well as sulfated or sulfonated adduct of a condensation product of ethylene oxide and/or propylene oxide with alkylamine or diamine, being not limiting.

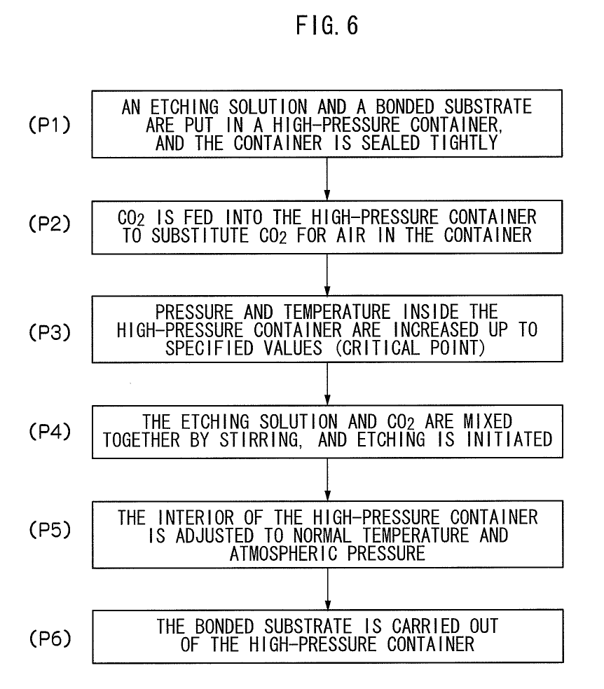

Next, the etching process is illustrated on the basis of the flowchart shown in FIG. 6.

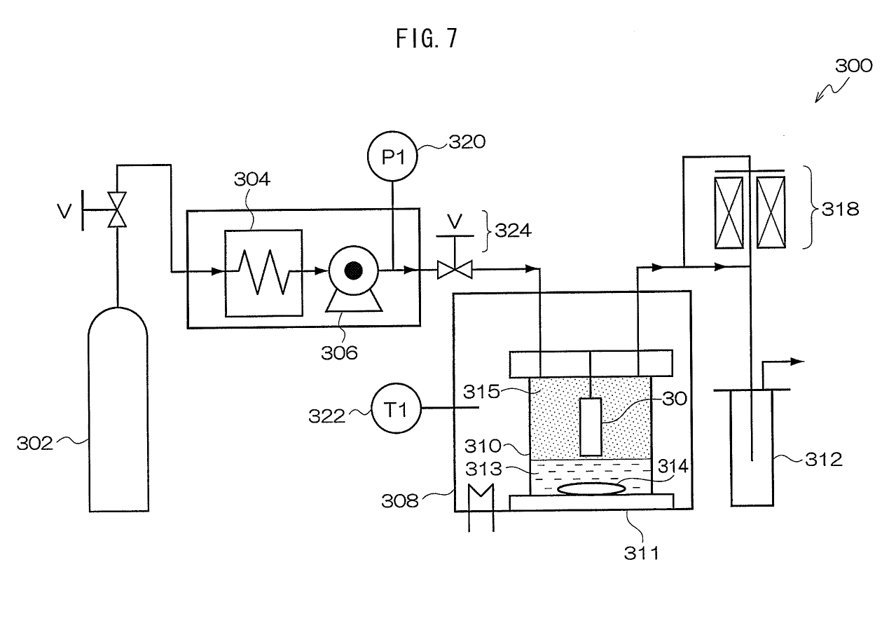

In the etching process, supercritical fluid apparatus 300 manufactured by JASCO Corporation, which has the configuration as shown in FIG. 7, can be suitably used. This apparatus 300 is equipped with a compressed-CO₂ cylinder 302 for feeding carbon dioxide used as a high-pressure liquid, a high-pressure container 310 for accommodating a body to be etched (bonded substrate) 30 and performing etching of the bonded substrate, a constant temperature bath 308 provided with a thermometer 322 and a stirring device 311, and so on. The carbon dioxide supplied from the compressed-CO₂ cylinder 302 undergoes cooling with a cooler 304, and introduced into the high-pressure container 310 installed in the constant temperature bath 308 by opening a valve 324 while controlling the pressure by means of a high-pressure pump 306 provided with a pressure gage 320. In addition, the inside pressure of the high-pressure container 310 can be controlled to a predetermined pressure by means of a back-pressure regulator 318. The carbon dioxide, the etching solution, the additive, the surfactant and so on which are emitted from the high-pressure container 310 at pressure-control time are collected within a trap 312.

First, the bonded substrate 30 (including the first substrate 10 and the second substrate 20) is placed in the high-pressure container 310, and then the etching solution 313 and a stirrer 314 coated with TEFLON (trade mark) are further admitted into the high-pressure container 310. After the container 310 is made airtight, the high-pressure container 310 is placed in the constant temperature bath (first Process (P1)). Although the temperature of the high-pressure container 310 is set for a value appropriate to the etching solution used, the lower limit thereof is preferably set for a value higher than the temperature at which the high-pressure fluid used reaches its supercritical or subcritical state.

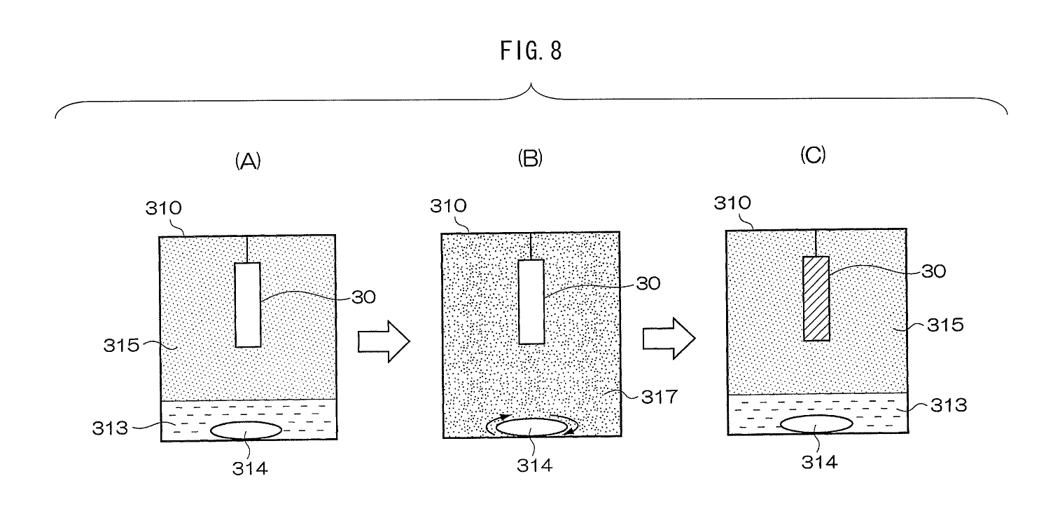

Carbon dioxide of purity greater than 99.99% is fed from the compressed-CO₂ cylinder into the high-pressure container 310 by the high-pressure pump 306 being driven (second Process (P2)). Concurrently with the feeding of CO₂, air is exhausted from the high-pressure container 310. And exhaustion of air and feeding of CO₂ are continued until CO₂ completely substitutes for air in the inner space of the high-pressure container 310. At this time, as shown in FIG. 8(A), the etching solution 313 and the carbon dioxide 315 are in an isolated state.

Thereafter, feeding of CO₂ into the high-pressure container 310 is continued in a state that evacuation of the high-pressure container 310 is halted and the inside temperature of the high-pressure container is further controlled, and thereby the inside pressure and temperature of the high-pressure container 310 are increased to those beyond the critical pressure and critical temperature of CO₂, respectively. Thus, the interior of the high-pressure container 310 is filled with supercritical CO₂ (third Process (P3)).

As in this embodiment of the invention, when supercritical carbon dioxide is chosen as the high-pressure fluid 315, the pressure in the high pressure container 310 is set to be 7.387 MPa which is the critical pressure of carbon dioxide, or higher, preferably in the range of 7.387 MPa or higher and 40.387 MPa or lower, more preferably in the range of 10 MPa or higher and 20 MPa or lower. The temperature in the high pressure container 310 is set to be 304.5 K which is the critical temperature of carbon dioxide, or higher, preferably in the range of 304.5 K or higher and 573.2 K or lower, more preferably 304.5 K or higher and 473.2 K or lower.

The charging ratio of the high-pressure fluid 315 and the etching solution 313 in the bath has no particular limits, and it can be chosen appropriately with consideration given to the concentration and reaction conditions of the etching solution. However, the reaction becomes difficult to proceed when the amount of the etching solution prepared is too small, so it is appropriate that the etching solution be contained in a proportion of at least 0.01 wt % with respect to the high-pressure fluid in a state below the critical point.

Then, as shown in FIG. 8(B), the supercritical carbon dioxide 315 and the etching solution 313, to which an additive and a surfactant are added, are stirred and mixed together on the inside of the high-pressure container 310 by the start of stirring, and the resulting mixed fluid 317 is brought into a state of covering the bonded substrate 30 and initiate the etching (fourth Process (P4)). The fluid 317 prepared by stirring and mixing the supercritical carbon dioxide 315, which is low in viscosity and high in diffusion constant, and the etching solution 313 penetrates through the channel 12 from the opening 14a even when the channel 12 is fine and complex in shape as in the case of ink channels 12 of an inkjet recording head, and reaches the opening 14b at which the surface of the second substrate 20 is laid bare, thereby performing etching.

The etching reaction generates air bubbles. It is difficult to eliminate the bubbles from the channel 12 of a complex and fine structure by the method depending solely on stirring without using a high-pressure fluid. However, by performing the etching while stirring and mixing supercritical carbon dioxide and the etching solution, the supercritical carbon dioxide efficiently eliminates the bubbles generated by etching; as a result, unevenness in etching can be effectively suppressed.

The mixed etching fluid 317 containing the high-pressure fluid 315 and the etching solution 313 is fed to the second substrate 20 via the channel 12 of the first substrate 10, and thereby the spot situated at the opening 14b is etched locally and evenly to form the nozzle hole 22 communicating with the channel 12 with high accuracy (FIG. 2(E)).

The etching treatment time may be determined according to the thickness of the second substrate 20 and so on, and it is generally chosen as appropriate from a time range of 0.001 second to about several months.

After the etching is carried out for the predetermined time, the stirring is halted, and at the same time, the inside pressure of the container 310 is reduced to below atmospheric pressure as the back pressure is controlled with the back-pressure regulator 318. Thus, the carbon dioxide, the etching solution, the surfactant and the additive are released into the trap (fifth Process (P5)). At this time, as shown in FIG. 8(C), the carbon dioxide 315 and the etching solution 313 are separated by halting the stirring.

The bonded substrate 30 having the nozzle hole 22 formed by the etching using the high-pressure fluid is carried out of the high-pressure container 310 (sixth Process (P6)).

[Removal of Protective Film]

After the formation of nozzle hole 22 in the second substrate 20 through the etching process, the second protective film 26 provided on the second substrate 20 is removed (FIG. 2(F)).

The second protective film 26 may be removed by ashing treatment with oxygen plasma or by using an exclusive remover. As a resist remover, STRIPPER-502A manufactured by TOKYO OHKA KOGYO CO., LTD., AZ Remover 100 manufactured by AZ Electronic Materials, and so on may be used.

On the other hand, when the second protective film 26 is formed by using a resist material, such as polymethylphenylsilane, whose solubility in supercritical carbon dioxide can be changed from the insoluble state to the soluble state by light exposure, it is preferred that the protective film 26 be removed by using supercritical carbon dioxide (high pressure fluid) after light exposure.

Through the foregoing processes, a high-accuracy head member 32 formed without any misalignment between the channel 12 and the nozzle hole 22 can be obtained.

In addition, by bonding the unprocessed second substrate 20 to the first substrate 10 after the formation of the channel 12 in the first substrate 10, variations in depth at the time of forming a channel can be controlled effectively. Further, even in the case of making a structure having plural complex and fine channels and nozzles, such as an inkjet recording head, which is impossible to make by conventional wet etching, the nozzles are formed in a condition that the etchant is transported uniformly even into fine portions. So, variations in nozzle shape can be made extremely narrow.

Furthermore, alignment of the first substrate 10 with the second substrate 20 is not required before or after these substrates are bonded together, irrespective of whether they are the same kind of material or different kinds of materials, so the range of choice for the first substrate 10 in particular can be widened, and reductions in number of processes and manufacturing cost can also be achieved.

### (2) Second Embodiment of the Invention

Although the case where a single substrate, or in other words one substrate made from one kind of material, is used as the second substrate is described in the first embodiment of the invention, a multilayer substrate prepared in advance by lamination of plural layers (substrates) including a second substrate may be used. For instance, the method of using a silicon substrate to which a supporting substrate is bonded and the method of using an SOI (Silicon On Insulator) substrate can be adopted. By using such a substrate made up of plural layers, the second substrate 20 can be treated as a thicker substrate, and improvements in handling and yield can also be achieved. Incidentally, the supporting substrate may be removed in the final process after the nozzle hole 22 is formed in the second substrate 20 through the etching process.

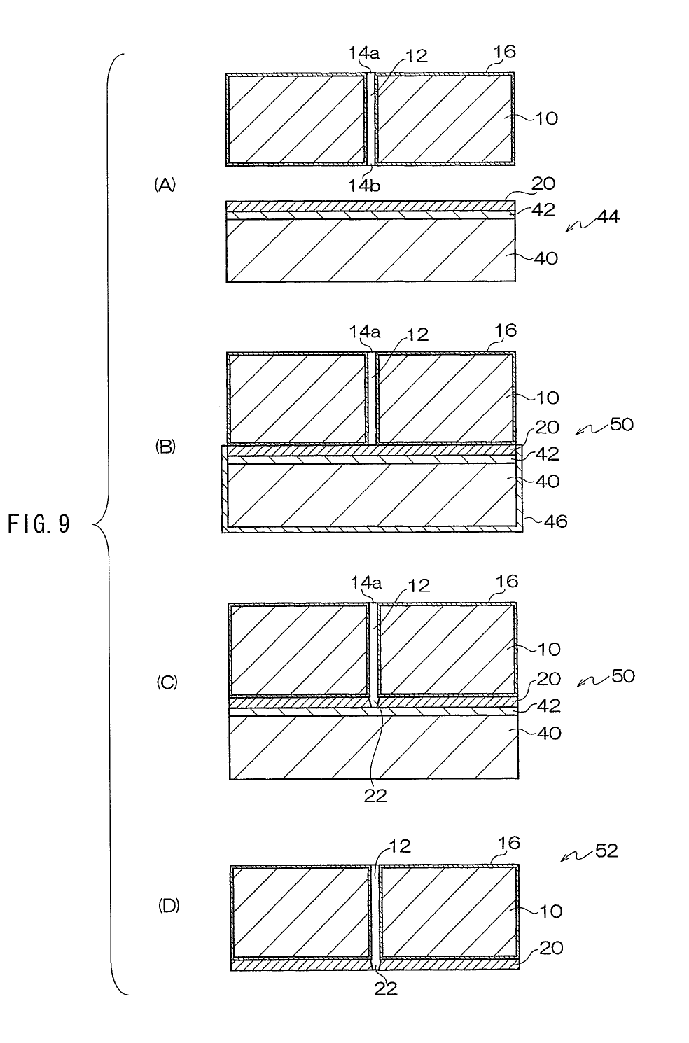

FIG. 9 is a flowchart showing processes included in the second embodiment of the invention.

### [Preparation of Substrate]

As to the first substrate 10, as with the first embodiment of the invention, the first substrate 10 having the opening 14a or 14b formed on at least one surface thereof and the channel 12 passing through the inside thereof is prepared. After the channel 12 is formed in the silicon substrate e.g. in the same manner as with the first embodiment of the invention, the protective film 16 is formed on the outer surface of the substrate 10 and the inner surface of the channel 12 by a dry process.

On the other hand, the second substrate 20 supported on a supporting substrate (support) is prepared as a second substrate. It is preferred that a difference in thermal expansion coefficient be as small as possible between materials of the supporting substrate and the second substrate. More specifically, the supporting substrate is preferably a member having a thermal expansion coefficient equivalent to that of the second substrate. As a substrate into which the second substrate and the supporting substrate are integrated, an SOI substrate can be suitably used. As shown in FIG. 9(A), the SOI substrate 44 has a structure (SOI structure) that a thin silicon layer 20 (active layer) having a thickness equivalent to that of the second substrate is formed on a silicon substrate 40 as the support via a BOX (Buried oxide) layer (silicon dioxide film) 42 as an insulation film. The method of making the SOI substrate 44 has no particular restriction, and it is possible to use the SOI substrate 44 made e.g. by a bonding method. Alternatively, the support 40 is not necessarily required to be a silicon substrate, but a substrate having e.g. a structure that a silicon layer acting as the second substrate is provided directly on an insulating substrate may be used.

[Bonding]

The second substrate 20 (SOI substrate 44) is bonded to one surface of the first substrate 10 where the opening 14b of the channel 12 is formed so as to cover the opening 14b, thereby providing the bonded substrate 50. The bonding of both substrates 10 and 44 may be either direct bonding or room-temperature bonding.

Although the size (length) of the opening 14b for the nozzle is determined depending on the thickness of the second substrate 20, the general tendency is that the thinner the thickness of the second substrate, the more difficult it becomes to handle the second substrate in the bonding process. However, as long as the second substrate 20 is supported on the support 40, the second substrate 20 obtains an improvement in handling and can be bonded to the first substrate 10 with ease.

After the bonding, a protective film 46 for etching is formed on bare surfaces of the second substrate 20 and the supporting substrate 40 (FIG. 9(B)). This protective film 46 for etching corresponds to the second protective film 26 provided on the second substrate in the first embodiment of the invention, and can be formed e.g. by coating a resist material in accordance with a spin coating method, a spray coating method, a dipping method or so on and then giving heat treatment to the resist material coated.

[Etching]

After the bonding process, the mixed etching fluid 317 containing a high-pressure fluid and an etching solution is fed to the second substrate via the channel 12 of the first substrate 10 by using the supercritical fluid apparatus 300 having the configuration as shown in FIG. 7 in the same manner as in the first embodiment of the invention. By making the supercritical fluid and the etching solution into an emulsion, the viscosity at the site of etching reaction is lowered, and the etching reactant species can be fed to the second substrate via the opening 14b of the channel 12. Thus, anisotropic etching is locally performed in the portion of the second substrate 20 that is laid bare by the opening 14b, and a tapered nozzle hole 22 communicating with the channel 12 is formed.

[Removal of Protective Film and Supporting Substrate]

After the etching, not only the protective film 46 but also the supporting substrate 40 and oxide film 42 are removed.

An exclusive remover may be applied to the protective film 46. When polymethylphenylsilane is used as the protective film, the removal thereof may be performed by exposure to light and subsequent dissolution in supercritical carbon dioxide.

On the other hand, examples of a method for removing the supporting substrate 40 include a mechanical method utilizing grinding, CMP or the like, wet etching by means of KOH, TMAH or the like, plasma etching by means of a fluorine-containing gas (e.g. SF₆, CF₄), and etching by means of XeF₂ gas.

Furthermore, the oxide film 42 remaining on the outside of the second substrate 20 is removed. Examples of a method for removing the oxidized film 42 include a mechanical method utilizing grinding, CMP or the like, wet etching by means of hydrofluoric acid, buffered hydrofluoric acid or the like, plasma etching by means of a fluorine-containing gas (e.g. SF₆, CF₄), and etching by means of the vapor from hydrofluoric acid.

Through the foregoing processes, as with the first embodiment of the invention, the nozzle hole 22 free of misalignment with the channel 12 can be formed by uniform etching, and that without requiring any operation for alignment. In addition, since handling of the second substrate is improved, the inkjet recording head member in which nozzle holes are formed with high accuracy can be manufactured in high yield.

The foregoing are descriptions of the invention, but the embodiments of the invention as mentioned above should not be construed as limiting the scope of the invention.

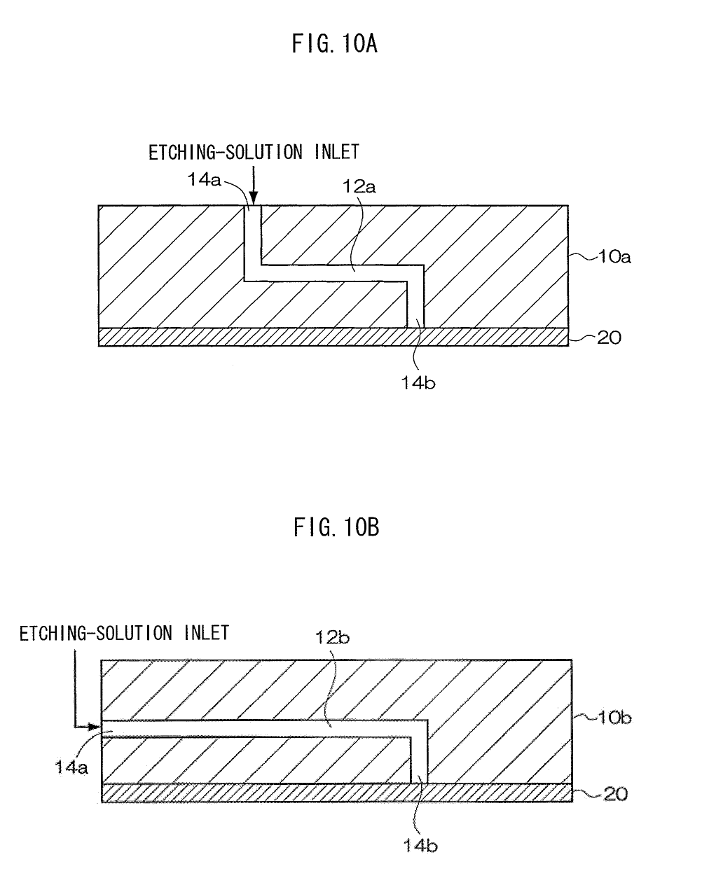

For instance, it is essential for the channel passing through the inside of a first substrate only that the opening thereof is formed on at least one side of the first substrate, and the first substrate used may have a channel complicated in structure. Specifically, as shown in FIG. 10A, the channel 12a may be bent in the interior of the substrate 10a and have its openings 14a and 14b at both surfaces of the substrate 10a, respectively, or as shown in FIG. 10B, the openings 14a and 14b of the bent channel 12b may be formed on one surface and one flank of the first substrate 10b, respectively.

Even when a channel is bent in the interior of a substrate as mentioned above, so long as the second substrate 20 is bonded to the surface of the substrate where the opening 14b of the channel 12 is formed and a mixed etching fluid containing a high-pressure liquid is fed into the channel 12 via the other opening 14a, the second substrate 20 is etched via the channel 12 and a nozzle hole can be formed with high accuracy.

Additionally, the method of forming a nozzle hole 22 in accordance with the invention is not limited to the manufacturing of an inkjet recording head, but also applicable e.g. to the manufacturing of a microdevice having a fine channel 12 and a nozzle, and to the formation of a nozzle thereof.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

All publications, patent applications, and technical standards mentioned in this specification are herein incorporated by reference to the same extent as if each individual publication, patent application, or technical standard was specifically and individually indicated to be incorporated by reference.

What is claimed is:

1. A method of forming a nozzle hole, comprising:
preparing a first substrate having a channel which passes through the inside thereof and an opening of the channel which is formed on at least one side thereof, and a second substrate for forming a nozzle hole communicating with the channel,
bonding the second substrate to the one side of the first substrate where the opening of the channel is formed so that the opening is blocked by the second substrate, and
etching the second substrate by feeding a mixed etching fluid, which contains a high-pressure fluid and an etching solution, to the second substrate via the channel of the first substrate, thereby forming the nozzle hole communicating with the channel.

2. The method of forming a nozzle hole as described in claim 1, wherein the bonding comprises preparing the second substrate supported on a support and bonding the first substrate and the second substrate supported on the support together.

3. The method of forming a nozzle hole as described in claim 1, wherein the second substrate is a silicon substrate.

4. The method of forming a nozzle hole as described in claim 1, wherein the channel is formed into a cylindrical shape.

5. The method of forming a nozzle hole as described in claim 1, further comprising forming a first protective film against the mixed etching fluid at least on the inside of the channel of the first substrate before the etching.

6. The method of forming a nozzle hole as described in claim 1, further comprising forming a second protective film against the mixed etching fluid on the surface of the second substrate, except for a portion where the first substrate is bonded to the second substrate and a portion which communicates with the channel of the first substrate, after the bonding, and before the etching.

7. The method of forming a nozzle hole as described in claim 6, wherein the second protective film is removed with a high-pressure fluid after the etching.

8. A method of manufacturing an inkjet recording head, comprising forming a nozzle hole in accordance with the method as described in claim 1.
